(19) United States
(12) Patent Application Publication
(10) Pub. No.: US 2009/0202194 A1
(43) Pub. Date: Aug. 13, 2009

(54) OPTICAL MEASURING DEVICE FOR DETERMINING TEMPERATURE IN A CRYOGENIC ENVIRONMENT AND WINDING ARRANGEMENT WHOSE TEMPERATURE CAN BE MONITORED

(76) Inventors: Thomas Bosselmann, Marloffstein (DE); Hagen Hertsch, Erlangen (DE); Martino Leghissa, Wiesenthau (DE); Marijn Pieter Oomen, Erlangen (DE); Michael Willsch, Jena (DE)

Correspondence Address: SCHIFF HARDIN, LLP;PATENT DEPARTMENT, 6600 SEARS TOWER, CHICAGO, IL, 60606-6473, US

(21) Appl. No.: 12/301,714

(22) PCT Filed: Apr. 12, 2007
(86) PCT No.: PCT/EP07/53589

§ 371 Date: Nov. 20, 2008

(30) Foreign Application Priority Data
Jun. 1, 2006 (DE) 102006025700.6

(51) Int. Cl. G02B 6/00; G01K 11/00

(52) U.S. Cl. 385/12; 374/161; 374/E11.016

(57) ABSTRACT

An optical measuring device for determining temperature in a cryogenic environment includes at least one optical waveguide provided with at least one fiber Bragg grating sensor that is interrogated by a light signal. The device includes a light injector that injects light into the at least one fiber Bragg grating sensor, and an evaluation unit that determines a temperature value from the modulated light signal emanating from the at least one fiber Bragg grating sensor. The device includes at least one jacket that non-rigidly encloses the optical waveguide, at least in the region of the at least one fiber Bragg grating sensor. The jacket has a larger coefficient of thermal expansion, at least at cryogenic temperatures, than the optical waveguide. A winding arrangement for use in a cryogenic environment is provided with such a device for temperature monitoring of a conductor of the winding arrangement.

### BACKGROUND OF THE INVENTION

1. Field of the Invention

The invention concerns an optical measurement device for temperature determination in a cryogenic environment. The measurement device is of the type having at least one optical wave guide provided with at least one fiber Bragg grating sensor, via which the at least one fiber Bragg grating can be interrogated by means of a light signal. The measurement device furthermore has a light injector that injects the light signal into the at least one optical wave guide, and evaluation unit to determine a temperature value from a light sensor arriving from at least one fiber Bragg grating sensor. The invention also concerns a winding arrangement whose temperature can be monitored.

2. Description of the Prior Art

Superconductive magnets that are used, for example, in magnetic resonance tomography systems are cooled to a temperature of 120 K or lower with a cryogenic coolant, depending on the employed superconductor type. For example, liquid helium which cools the magnet to 4.2 K is suitable for a magnet executed with a low-temperature superconductor. An event known as a quench, wherein the superconductor becomes normally-conductive, can occur in such a superconductor due to the most varied disruptive influences. This quench process initially begins at a point and propagates with high speed over the entire superconductor. This is associated with a severe heating of the superconductor which results in a high vaporization loss of cryogenic coolant. The magnet must thereupon be immediately deactivated. In order to avoid damage to the magnet, it is necessary to detect the quench process as promptly as possible and with optimal spatial resolution. For example, its point of origin can be localized by acoustic emissions that are connected with the quench event. Particularly in magnetic resonance apparatuses, this proves to be quite difficult since magnetic resonance apparatuses are normally composed of numerous coils arranged in complicated geometry. An additional possibility for quench detection makes use of a differential voltage measurement at the windings. The location of the quench can therefore likewise be locally limited. However, this leads to a large number of voltage taps, particularly in magnetic resonance apparatuses, which makes the winding process very complicated. Moreover, the resistive voltages to be measured are superimposed with very high inductive portions.

An optical device for temperature measurement of a normally-conductive magnetic resonance tomography coil is specified in United States Patent Application Publication 2005/0129088 A1. A tube-shaped sheath is wound around the winding body, into which sheath an optical wave guide mechanically decoupled from said sheath is inserted. The optical wave guide is provided with multiple fiber Bragg gratings with which the coil temperature (which can be at room temperature or higher) can be monitored with spatial resolution. Since the temperature-dependent wavelength change of “naked” fiber Bragg grating sensors in the range of cryogenic temperatures (i.e. temperatures that are at 120 K and lower) is not present in practice, the optical device specified in this document is not suitable for use in such a cryogenic environment.

### SUMMARY OF THE INVENTION

An object of the present invention is to provide an optical measurement device that is suitable for use in a cryogenic environment. It is also an object of the present invention to provide a winding arrangement whose temperature can be monitored under cryogenic conditions.

The above object is achieved in accordance with the present invention by an optical measurement device for a temperature determination in a cryogenic environment, having at least one optical waveguide provided with at least one fiber Bragg grating sensor that can be interrogated by a light signal, a light injector that injects the light signal into the optical waveguide, an evaluation unit that determines a temperature measurement value from a light signal from the fiber Bragg grating sensor, and at least one jacket element that at least partially surrounds the at least one optical waveguide, without a rigid connection thereto, at least in the region of the at least one fiber Bragg grating element, and wherein the at least one jacket element has a coefficient of thermal expansion that is larger than the coefficient of thermal expansion of the optical waveguide, at least at cryogenic temperatures.

Due to the non-positive (non-rigid) contact of the at least one jacket element with the at least one optical wave guide, the expansion of the at least one jacket element given a temperature increase or the contraction of the at least one jacket element given a temperature drop is directly transferred to the at least one optical wave guide, and therefore to the at least one fiber Bragg grating sensor. Even if the fiber Bragg grating sensor itself has a negligible coefficient of thermal expansion in the cryogenic temperature range of 120 K and below, upon a temperature change the at least one jacket element measurably affects the focal wavelength of the at least one fiber Bragg grating due to the existing or, respectively, greater coefficient of expansion.

It is thus advantageous when for the at least one jacket element to be formed from a polymer material (in particular from PMMA). Polymer material (in particular PMMA) has a high coefficient of thermal expansion in the cryogenic temperature range of 120 K and below. For example, PMMA exhibits a coefficient of thermal expansion of >10⁻⁶ per K at a temperature in the range of approximately 4 K (liquid helium) up to 20 K while the coefficient of thermal expansion of, for example, glass of an optical fiber is <10⁻⁷ per K. Such a polymer material (in particular PMMA) is additionally characterized by a low intrinsic heat capacity.

Furthermore, it is advantageous for the at least one jacket element to exhibit a pronounced expansion in the length direction of the at least one optical wave guide in the region of the at least one fiber Bragg grating sensor. The thickness of the at least one jacket element is thus kept as small as possible in the region of the associated at least one fiber Bragg grating sensor in order to minimize the heat capacity of the at least one jacket element. An optimally short response time of the at least one fiber Bragg grating sensor is thereby ensured.

The at least one jacket element advantageously tapers towards its ends in the length direction of the at least one optical wave guide. For example, if the at least one optical wave guide with at least one fiber Bragg grating sensor and the at least one jacket element associated with the at least one fiber Bragg grating sensor is embedded in a composite material (for example casting resin), a compression by the composite material is avoided in such an embodiment of the at least one jacket element.

It is additionally advantageous for the at least one jacket element to be fashioned to be rotationally symmetrical around the at least one optical wave guide. In particular, the at least one jacket element tapers conically at both ends. Due to such a symmetrical design of the at least one jacket element, the expansion and contraction forces emanating from the at least one jacket element that act on the at least one optical wave guide are distributed uniformly over its extent. The expansion and contraction of the at least one fiber Bragg grating sensor therefore ensues uniformly so that the light signal (reflected on at least one fiber Bragg grating senor, for example) exhibits an optimally small bandwidth.

Multiple fiber Bragg grating sensors are advantageously provided at different points along the at least one optical wave guide with respective associated jacket elements. A temperature distribution can thus be determined with spatial resolution, and the event location can be precisely limited given point events, for example a sudden, locally limited temperature increase. The resolution is determined solely by the spacing of the individual fiber Bragg grating sensors from one another. For example, if what is known as the wavelength multiplexer method is applied with the optical measurement device according to the invention, normally up to 10 fiber Bragg grating sensors can be arranged in succession in an optical wave guide. Each fiber Bragg grating sensor thereby has a different focal wavelength. For this the light signal injected into the optical wave guide by the injection means must exhibit a wavelength range that covers all focal wavelengths. For evaluation, the evaluation means hereby advantageously possesses a spectrometer (for example a Fabry-Perrot interferometer).

Moreover, a time multiplexing method (OTDR: Optical Frequency Doman Reflectometry) can be used as an alternative to the wavelength multiplexing method, a nearly unlimited number of fiber Bragg grating sensors can be arranged in an optical wave guide. The sensors can also be spatially differentiated given an identical focal wavelength. For example, the evaluation means can exhibit an edge filter for the evaluation of the light signal scattered at the fiber Bragg grating sensors.

It is advantageous when the light signal from the injection means is injected in pulses into the at least one optical wave guide with a pulse frequency in a range from 500 Hz to 10 kHz. It is thus ensured that the change of the temperature distribution can be temporally resolved given a high propagation speed of a temperature change, as it occurs given a quench process in a superconductor, for example.

The above object also is achieved in accordance with the present invention by a winding arrangement with at least one winding body composed of a number of windings of at least one electrical conductor, and an optical measurement device as described above that determines a temperature of the electrical conductor in a cryogenic environment, the jacket element of the optical waveguide being in thermal contact with the winding body.

The advantages explained above for the optical measurement device according to the invention are applicable to the winding arrangement as well.

It is advantageous to arrange the at least one optical wave guide internally and/or externally on the winding body.

The winding body is advantageously provided with a composite material, in particular with casting resin (for example epoxy resin). The composite material primarily serves for mechanical stabilization of the at least one conductor in the winding body. The composite material additionally serves for electrical insulation of two adjacent windings. Moreover, the composite material advantageously possesses a good heat conductivity. It is therefore ensured that an initially locally limited temperature increase propagates quickly and thus can be detected early by the nearest fiber Bragg grating sensor.

It is advantageous when at least one optical wave guide is embedded in the composite material. The at least one optical wave guide can thus be positioned optimally close to the at least one conductor, and the at least one optical wave guide is protected from external influences and additionally is mechanically stabilized by the composite material. Due to the embedding it is additionally ensured that the at least one optical wave guide and in particular the at least one fiber Bragg grating sensor are arranged at a fixed, invariable distance from the at least one electrical conductor to be monitored.

The composite material of the winding body advantageously simultaneously serves as a jacket element of the at least one fiber Bragg grating sensor. This can be ensured a suitable composite material, in particular a casting resin.

The at least one electrical conductor is advantageously at least one superconductor. The at least one superconductor can thereby be a low-temperature or even a high-temperature superconductor. It is thus possible to promptly detect a quench event occurring in at least one superconductor and to localize it in an optimally precise manner given the use of sufficiently many distributed fiber Bragg grating sensors. A thermal stress of the superconductor by the at least one optical wave guide is nonexistent in principle.

### BRIEF DESCRIPTION OF THE DRAWINGS

FIG. 1 illustrates an optical measurement device with a winding arrangement in a cryogenic medium, constructed and operating in accordance with the present invention.

FIG. 2 is a cross-section through the winding arrangement shown in FIG. 1.

FIG. 3 is a longitudinal section through an optical waveguide embedded in composite material, having a fiber Bragg grating sensor and a jacket element associated with the fiber Bragg grating sensor, in accordance with the present invention.

FIG. 4 is a cross-section through the optical waveguide of FIG. 3.

### DESCRIPTION OF THE PREFERRED EMBODIMENTS

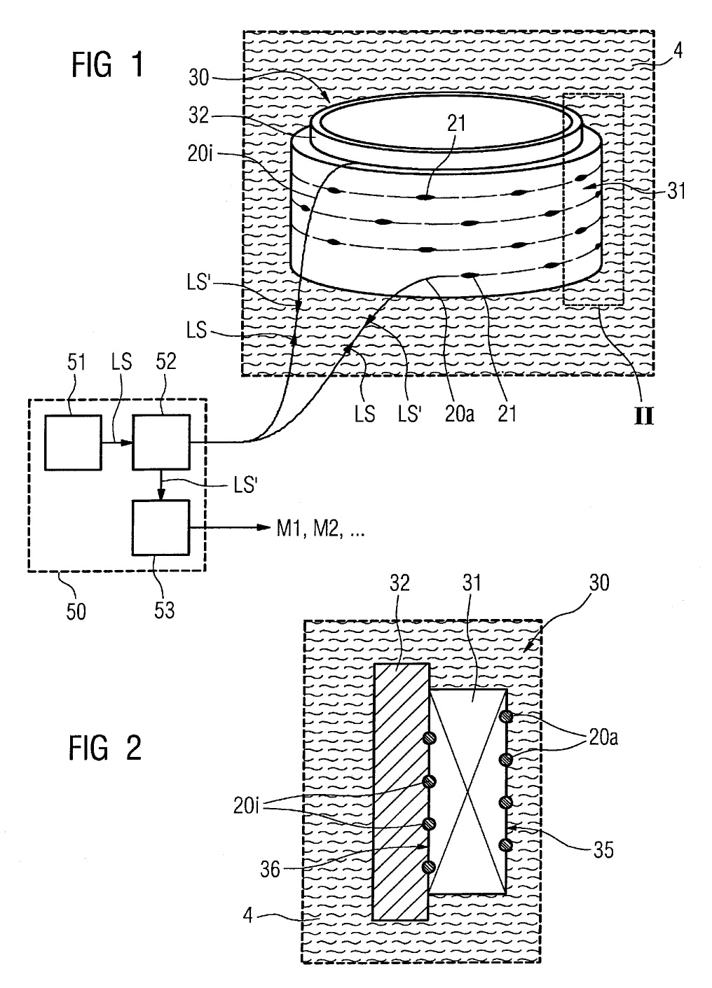

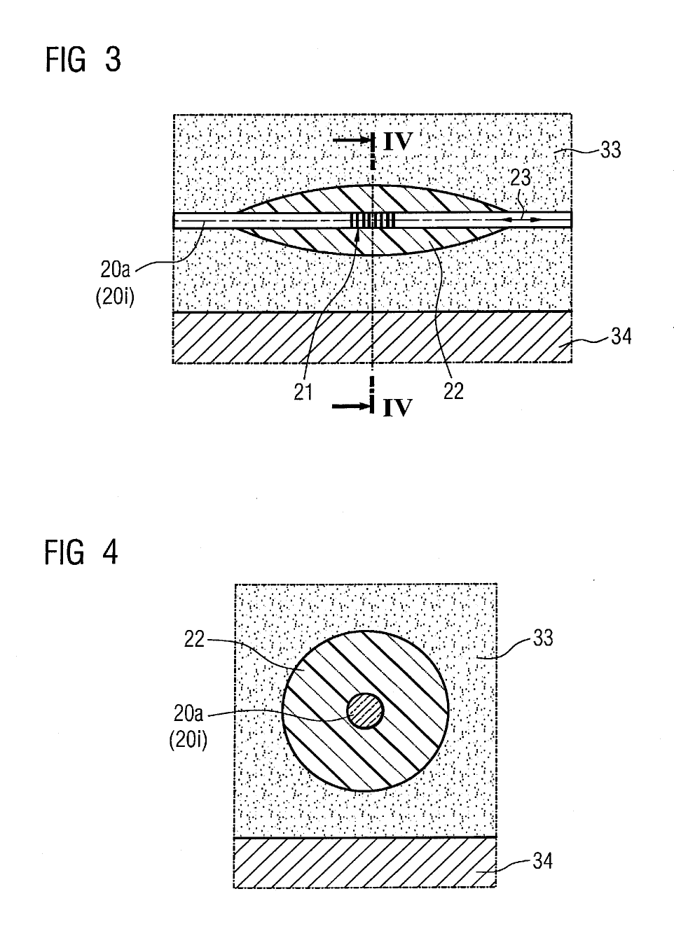

According to the invention, an optical measurement device with a winding arrangement 30 in a cryogenic medium 4 (for example liquid helium or liquid nitrogen) is shown in FIG. 1. The winding arrangement 30 thereby exhibits a winding body 31 arranged on a winding support 32. However, the winding body can also be executed in a self-supporting manner, i.e. without winding support 32 (not shown in FIG. 1). The winding body 31 is thereby fashioned from a plurality of windings of a superconductive conductor 34 (see FIG. 3). The superconductive conductor 34 can thereby be a low-temperature superconductor or a high-temperature superconductor. Depending on the superconductor type, the conductor 34 can be band-shaped, be executed with rectangular cross-section or even exhibit a round cross-section. Both winding supports 32 and winding bodies 31 are of a hollow cylinder shape in the presented exemplary embodiment. The winding body 31 respectively possesses an optical wave guide 20i, 20a both on its inner side facing towards the winding carrier 32 and on its outer side 35 facing away from the winding carrier 32. According to the exemplary embodiment in FIG. 1, the outer optical wave guide 20a is shown wound around the winding body 32 [sic]. The inner optical wave guide 20i can likewise be arranged wound parallel to this (not shown in FIG. 1). However, other embodiments to arrange the optical wave guides 20i and 20a parallel to the inner or, respectively, outer winding body surface are also conceivable. For example, the optical wave guides 20i, 20a could also be arranged in a meandering shape. The optical wave guides 20i, 20a are provided with numerous temperature-sensitive fiber Bragg grating sensors 21. The respective optical wave guide 20i, 20a and the associated fiber Bragg grating sensors 21 are advantageously arranged such that the fiber Bragg grating sensors 21 form a “blanketing” sensor network. The fiber Bragg grating sensors 21 are advantageously arranged equidistant from one another. If a quench event in which the superconductor 34 suddenly becomes normally-conductive at a point occurs in the superconductor 34, such that what is known as a “hot spot” forms at the event location, this can be detected by a fiber Bragg grating sensor 21 or multiple fiber Bragg grating sensors 21.

The fiber Bragg grating sensors 21 can respectively exhibit different specific focal wavelengths (what are known as Bragg wavelengths). The fiber Bragg grating sensors 21 are interrogated by a light signal LS that is generated by a broadband light source 51. The light signal LS is injected into the fiber Bragg grating sensors 21 via a coupler 52 and one or more optical wave guides 20i, 20a. A portion of the injected light signal LS with the respective focal wavelength is reflected back as a partial reflex signal in each fiber Bragg grating sensor 21. In contrast to this, the remaining part of the light signal LS passes the appertaining fiber Bragg grating sensor 21 and, if applicable, strikes the next fiber Bragg grating sensor 21. A light signal LS′ reflected back by the fiber Bragg grating sensors 21 is then present at the coupler 52, which light signal LS′ is composed of the partial reflex light signals of the individual fiber Bragg grating sensors 21. However, the focal wavelengths of multiple fiber Bragg grating sensors of an optical wave guide do not necessarily need to be different when, for example, what is known as an “optical time domain reflectometer” is used to differentiate the response signals of different fiber Bragg grating sensors.

If a fiber Bragg grating sensor 21 experiences a temperature change, its focal wavelength changes corresponding to the magnitude of the temperature change, and therefore to the wavelength yield (=the wavelength spectrum) of the partial reflex light signal reflected by the appertaining sensor 21. This variation in the wavelength yield serves as a measure for the temperature change to be detected. However, a transmission mode (not shown in Figures) is also conceivable. In contrast to the reflection mode, here the entire wavelength spectrum emitted by the light source 51 must be examined for missing wavelength ranges. These missing wavelength ranges correspond to the respective focal wavelengths of the individual sensors 21.

The light signal LS′ arriving from the fiber Bragg grating sensors 21 and injected again into the coupler 52 is directed by the coupler 52 to an evaluation unit 53. This in particular comprises an optical transducer, an analog/digital converter and a digital signal processor. The optoelectronic transducer advantageously has a spectrally sensitive element for selection of the individual partial reflex light signals, for example in the form of a polychromator, and a light receiver (possibly also in multiple parts). Grid or diffraction spectrometers for analysis of the light spectrum are also conceivable. Given the use of an “optical time domain reflectometer”, for example, a cost-effective edge filter is also sufficient. An analog/digital conversion occurs in the analog/digital converter, following the optoelectronic transduction. The digitized output signal of the analog/digital converter is supplied to the digital signal processor, by means of which measurement values M1, M2, . . . for the temperatures detected in the fiber Bragg grating sensors 21 can be determined. In contrast to this, the coupler 52 can be omitted in the transmission mode. Here the light signal LS is injected at one end of the optical wave guide(s) 20a, 20i by means of the light source 51 and is detected by an optoelectronic transducer at the other end of the optical wave guide(s) 20a, 20i.

The light source 51, the coupler 52 and the evaluation unit 53 are combined into a transmission/reception unit 50, wherein the light source 51 and the coupler 52 can be considered as injection means to inject the light signal LS into the fiber Bragg grating sensors 21, and the evaluation unit 53 with optoelectronic transducer, analog/digital converter and digital signal processor can be considered as an evaluation means to determine a measurement value M1, M2, . . . for the respective temperature detected by the fiber Bragg grating sensors 21. In another exemplary embodiment (not shown), these sub-units or parts of these can be fashioned separate from one another, thus not as a joint transmission/reception unit 50. Moreover, a purely analog evaluation is also possible, for example by means of a hard-wired electronic circuit. No analog/digital converter would then be present, and the evaluation unit 53 would be realized by means of analog technology.

The measurement values M1, M2, . . . generated in the transmission/reception unit 50 are transmitted (for example by means of a radio transmission) to a data acquisition unit (not shown in FIG. 1). However, in principle the data transmission can also ensue via wires, electrically or optically. Moreover, the transmission/reception unit 50 and the data acquisition unit can also be fashioned as a common unit.

A cross-section through the winding arrangement 30 shown in FIG. 1 is depicted in FIG. 2. The optical wave guide segments of the individual windings of a respective optical wave guide 20a, 20i are arranged equidistantly.

An optical wave guide 20a, 20i is presented in longitudinal section in FIG. 3. The optical wave guide 20a, 20i is thereby embedded in a composite material 33 (in particular casting resin, for example epoxy resin) with which the superconductor 34 is mechanically stabilized in a winding body 31. The optical wave guide 20a, 20i thereby runs essentially parallel to the adjacent superconductor 34. Also shown is a fiber Bragg grating sensor 21 that is surrounded by a jacket element 22. The jacket element 22 is thereby non-positively connected with the optical wave guide 20a, 20i, and therefore is also non-positively connected with the fiber Bragg grating sensor 21. While the optical wave guide (which is normally produced from glass) at ≦120 K experiences nearly no expansion given a temperature change—the coefficient of thermal expansion is negligible—the jacket element 22 is fashioned from a material that directly exhibits a relatively large coefficient of thermal expansion at such low temperatures. In particular a polymer (for example PMMA; polymethylmethacrylate) is thereby considered as a jacket element material. While a temperature rise from 2 K to 20 K cannot be measured in practice with a “naked” fiber Bragg grating sensor 21 [sic], for example, this is possible without further measures with a fiber Bragg grating sensor 21 provided with a jacket element 22. Due to the non-positive connection of the jacket element 22 with the fiber Bragg grating sensor 21, the fiber Bragg grating sensor 21 likewise also expands with the jacket element 22 given a temperature increase. The expansion in particular ensues in the length direction 23 of the optical wave guide 20a, 20i since the jacket element 22 exhibits a pronounced expansion in the length direction. The grating constant of the fiber Bragg grating sensor 21 (and therefore the focal wavelength) changes (i.e. increases) due to the expansion. This variation can be directly interrogated by the injected light signal LS. The jacket element 22 shown in FIG. 3 is additionally arranged rotationally symmetrical around the optical wave guide 20a, 20i. The jacket element 22 narrows towards both sides in the length direction 23 of the optical wave guide 20a, 20i, such that it tapers conically in the depicted example. The jacket element 22 is thickest in the region of the fiber Bragg grating sensor 21, meaning that the distance between the optical wave guide 20a, 20i and the outer surface of the measurement element is maximum in the region of the fiber Bragg grating sensor 21, at least in the direction of the nearest superconductor 34.

Such a fiber Bragg grating sensor 21 can typically exhibit a diameter of approximately 200 μm and a length of approximately 10 mm. The thickness of the jacket element 22 is thereby at maximum 1 mm.

A cross-section through the optical wave guide 20a, 20i depicted in FIG. 3 is shown in FIG. 4. As already specified, the jacket element 22 is fashioned to be rotationally symmetrical relative to the optical wave guide 20a, 20i.

Although modifications and changes may be suggested by those skilled in the art, it is the intention of the inventors to embody within the patent warranted heron all changes and modifications as reasonably and properly come within the scope of their contribution to the art.

1-13. (canceled)

14. An optical measurement device for temperature determination in a cryogenic environment, comprising:
at least one optical waveguide comprising at least one fiber Bragg grating sensor that is interrogated by a light signal;
a light signal injector that injects said light signal into said at least one optical waveguide that is modulated, as a modulated light signal, dependent on the temperature of the environment in which said at least one fiber Bragg grating sensor is disposed;
at least one jacket element that at least partially, non-rigidly, surrounds said at least one optical waveguide at least in a region in which said at least one fiber Bragg grating sensor is disposed, said at least one jacket element having a coefficient of thermal expansion that is larger than a coefficient of thermal expansion of said optical waveguide, at least at cryogenic temperatures; and
an evaluation unit that detects said modulated light signal from said at least one fiber Bragg grating sensor to determine a temperature measurement value therefrom, said evaluation unit emitting an evaluation unit output corresponding to said temperature measurement value.

15. An optical measurement device as claimed in claim 14 wherein said at least one jacket element is formed of a polymer material.

16. An optical measurement device as claimed in claim 15 wherein said at least one jacket element is formed of PMNA.

17. An optical measurement device as claimed in claim 14 wherein said at least one jacket element is formed from a casting resin.

18. An optical measurement device as claimed in claim 14 wherein said at least one jacket element is comprised of material exhibiting a substantial expansion along a length direction of said at least one optical waveguide in said region of said at least one fiber Bragg grating sensor.

19. An optical measurement device as claimed in claim 14 wherein said at least one jacket element has opposite ends spaced from each other along a length direction of said at least one optical waveguide, and wherein said at least one jacket element tapers toward said opposite ends.

20. An optical measurement device as claimed in claim 14 wherein said at least one jacket element is rotationally symmetrical around said at least one optical waveguide.

21. An optical measurement device as claimed in claim 14 comprising a plurality of fiber Bragg grating sensors respectively disposed at different locations along a length of said at least one optical waveguide, each of said plurality of fiber Bragg grating sensors comprising a jacket element identical to said at least one jacket element.

22. An optical measurement device as claimed in claim 14 wherein said light injector emits said light signal as a pulsed light signal into said at least one optical waveguide, with a pulse frequency in a range between 500 Hz and 10 kHz.

23. A winding arrangement comprising:
a winding body comprising a plurality of windings of at least one electrical conductor operable in a cryogenic environment;
an optical measurement device for determining a temperature of said at least one electrical conductor in said cryogenic environment, said optical measurement device comprising at least one optical waveguide comprising at least one fiber Bragg grating sensor that is interrogated by a light signal, a light signal injector that injects said light signal into said at least one optical waveguide that is modulated, as a modulated light signal, dependent on the temperature of the environment in which said at least one fiber Bragg grating sensor is disposed, at least one jacket element that at least partially, non-rigidly, surrounds said at least one optical waveguide at least in a region in which said at least one fiber Bragg grating sensor is disposed, said at least one jacket element having a coefficient of thermal expansion that is larger than a coefficient of thermal expansion of said optical waveguide, at least at cryogenic temperatures, and an evaluation unit that detects said modulated light signal from said at least one fiber Bragg grating sensor to determine a temperature measurement value therefrom, said evaluation unit emitting an evaluation unit output corresponding to said temperature measurement value; and
said at least one jacket being in thermal contact with said winding body.

24. A winding arrangement as claimed in claim 23 wherein said at least one optical waveguide is mounted internally with respect to said winding body.

25. A winding arrangement as claimed in claim 23 wherein said at least one optical waveguide is mounted externally with respect to said winding body.

26. A winding arrangement as claimed in claim 23 wherein said winding body is surrounded by casting resin.

27. A winding arrangement as claimed in claim 26 wherein said at least one optical waveguide is embedded in said casting resin.

28. A winding arrangement as claimed in claim 23 wherein said at least one electrical conductor is comprised of superconducting material.
